(19) United States
(12) Patent Application Publication
(10) Pub. No.: US 2014/0081888 A1
(43) Pub. Date: Mar. 20, 2014

(54) Methods And Systems For Constructing Risk Parity Portfolios

(71) Applicants: Alex Cheng-yen Chung, New York, NY (US); John Francis Dermody, V, Kentfield, CA (US); Reha Husnu Tütüncü, New York, NY (US); Jinwei Wu, Scarsdale, NY (US)

(72) Inventors: Alex Cheng-yen Chung, New York, NY (US); John Francis Dermody, V, Kentfield, CA (US); Reha Husnu Tütüncü, New York, NY (US); Jinwei Wu, Scarsdale, NY (US)

(73) Assignee: GOLDMAN, SACHS & CO., New York, NY (US)

(21) Appl. No.: 13/620,180

(22) Filed: Sep. 14, 2012

(51) Int. Cl. G06Q 40/06

(52) U.S. Cl. 705/36 R

(57) ABSTRACT

A method and system for constructing risk parity portfolios wherein the overall portfolio risk is diversified by allocating the risk equally or substantially equally across various portfolio components. The system receives a selection of investments assets, covariance matrix of the assets, and constraints including bounds on the weights of the investment assets. The system optimizes a mathematical formulation that is constrained by the bounds on the weights of the investment assets to generate a solution that is used for constructing a risk parity portfolio having optimal asset allocations that result in a balanced risk contribution.

### BACKGROUND

Some investors seek to diversify their portfolio of investments to reduce investment risk. Historically, diversification has been achieved by allocating roughly equal weights to many securities. More sophisticated diversification methods seek allocations of balanced weights to different return factors. In quantitative portfolio construction, one method for achieving diversification is the risk parity approach which seeks to construct portfolios with balanced allocations of the risk budget.

When seeking portfolios that minimize deviations from risk parity in the presence of constraints, portfolio construction methodologies in the prior art suffer from structural deficiencies that can cause solution algorithms to miss the best available solution and return an inferior portfolio. Maillard et al. quantified the deviation from risk parity and sought to minimize the deviation measure to obtain a risk parity portfolio. However, Maillard et al.'s deviation measure suffers from the undesirable non-convexity property. The non-convex deviation measures have the tendency to change unpredictably as the portfolio is modified, and these functions may have multiple local minimizers that are not the global minimizer of the function. Algorithmically, the minimization of a non-convex function can be very difficult. The standard solution methods for non-convex minimization problems can only guarantee a local solution of the problem, and the local solution that the method produced may be very different from the global solution of the problem. Whether a local or a global solution is output may depend on several factors including the algorithm and the starting point chosen (e.g., initial conditions). As a consequence, the resulting portfolio may be inferior, and not representative of the risk parity sought. Maillard et al. have indicated that the numerical optimization of the deviation measures was “tricky” and proposed heuristic approaches to determine solutions in such cases. These issues with the non-convex measures of deviation are further compounded when the number of assets considered becomes large.

### BRIEF DESCRIPTION OF THE DRAWINGS

FIG. 1 is a diagram illustrating an example environment surrounding a risk parity portfolio generator.

FIG. 2 is a block diagram illustrating the risk parity portfolio generator controller.

FIG. 3 is a block diagram illustrating the risk parity portfolio generator components.

FIGS. 4A-B are logic flow diagrams illustrating construction of a risk parity portfolio.

FIG. 5A is a table illustrating example covariance matrix of assets.

FIG. 5B is a table illustrating example risk parity portfolio generated for the covariance matrix of FIG. 5A.

FIG. 5C is a graphical representation of component weights of a risk parity portfolio.

FIG. 6A is an example graphical user interface of a constraint report.

FIG. 6B is an example graphical user interface of a MCR report.

FIG. 6C is an example graphical user interface of an optimal weight report.

### DETAILED DESCRIPTION

Quantitative portfolio management seeks diversification across sources of returns and risks in a portfolio. The risk parity (hereinafter “RP”) approach in portfolio construction assists in building portfolios where the overall portfolio risk is diversified by allocating it equally across the different portfolio components. When the presence of discretionary or other constraints, such as bounds on the weights of different portfolio components prevents the portfolio manager from reaching true risk parity, the next best solution is an “approximate risk parity portfolio,” namely, a portfolio that satisfies all the constraints and at the same time minimizes the deviation from risk parity. Embodiments of the risk parity generator (hereinafter “RPPG”) described herein implement a novel approach for constructing a long-only RP portfolio and an additionally constrained approximate RP portfolio through indirect characterizations of risk parity. These indirect characterizations, referred to as optimization problems, lead to a unique solution, and can be solved reliably and efficiently in accordance with embodiments of the present invention.

Various implementations of the RPPG embodiments will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### Computing Environment and RPPG Controller

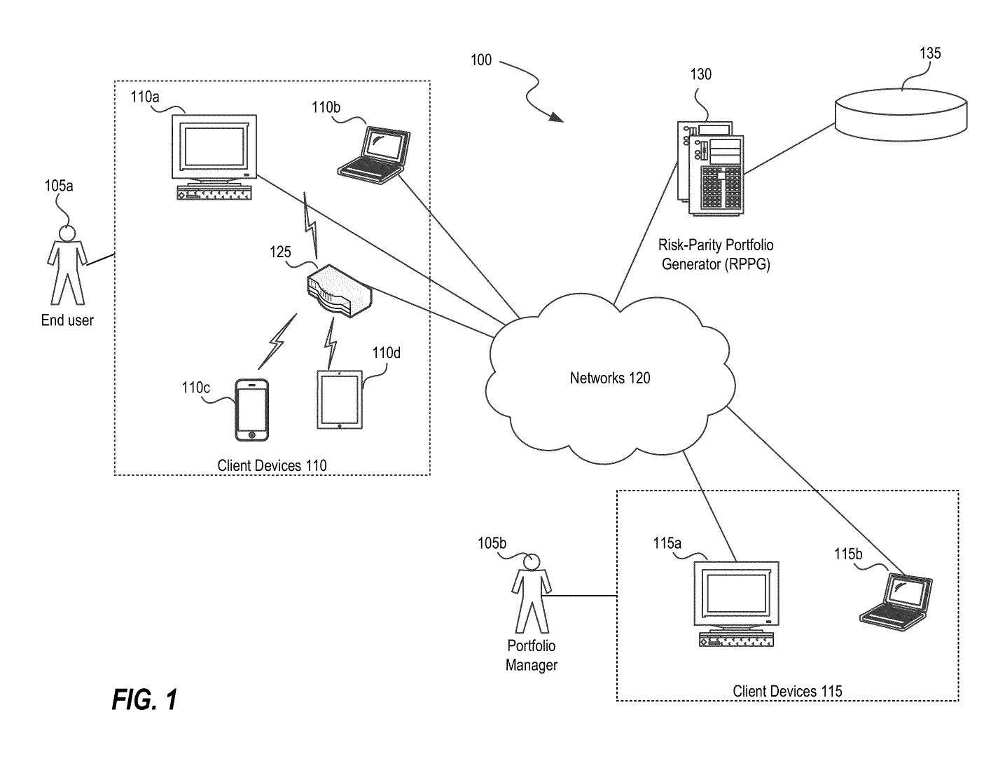

The RPPG may be implemented in a suitable computing environment such as the one shown in FIG. 1. In the environment 100, client devices 110, 115 and server computers (e.g., RPPG 130) may connect to and/or communicate with each other across networks 120. Networks 120 may include private networks and public networks (e.g., the Internet). Client devices 110, such as desktop computer 110a, laptop computer 110b, mobile devices 110c, tablets 110d, and/or the like, may be operable by an end user 105a, while the client devices 115, such as desktop computer 115a, laptop 115b, and/or the like, may be operable by portfolio managers 105b to access the facilities of RPPG 130. Client devices 110, 115 may use their network interfaces to connect to networks 120, either directly, or via wireless router 125. RPPG 130 is represented as a server in the environment 100, and may be coupled to one or more databases and/or database tables represented as database 135. Client devices may access the facilities of RPPG 130 via networks 120 using secure communications protocols such as File Transfer Protocol (FTP), HyperText Transfer Protocol (HTTP), Secure HyperText Transfer Protocol (HTTP(s)), Secure Socket Layer (SSL), and/or the like. In some implementations, the RPPG may be implemented as a plug-in or add-on to a web browser, or other computing environments such as MATLAB. In other implementations, instead of being implemented as a server, the RPPG may be a component residing in client devices 110, 115. The term “server” as used throughout this application refers generally to a computer, device, program, or combination thereof that processes and responds to requests from remote client devices operated by users across a network. The term “client” generally refers to a computer, program, device, user and/or combination thereof that processes and sends requests and receives and processes responses from remote servers across a network.

Aspects and implementations of the RPPG will be described in the general context of computer-executable instructions, such as routines executed by a general-purpose computer, a personal computer, a server, and/or other computing systems. The RPPG may also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, as well as any data processor or any device capable of communicating with a network.

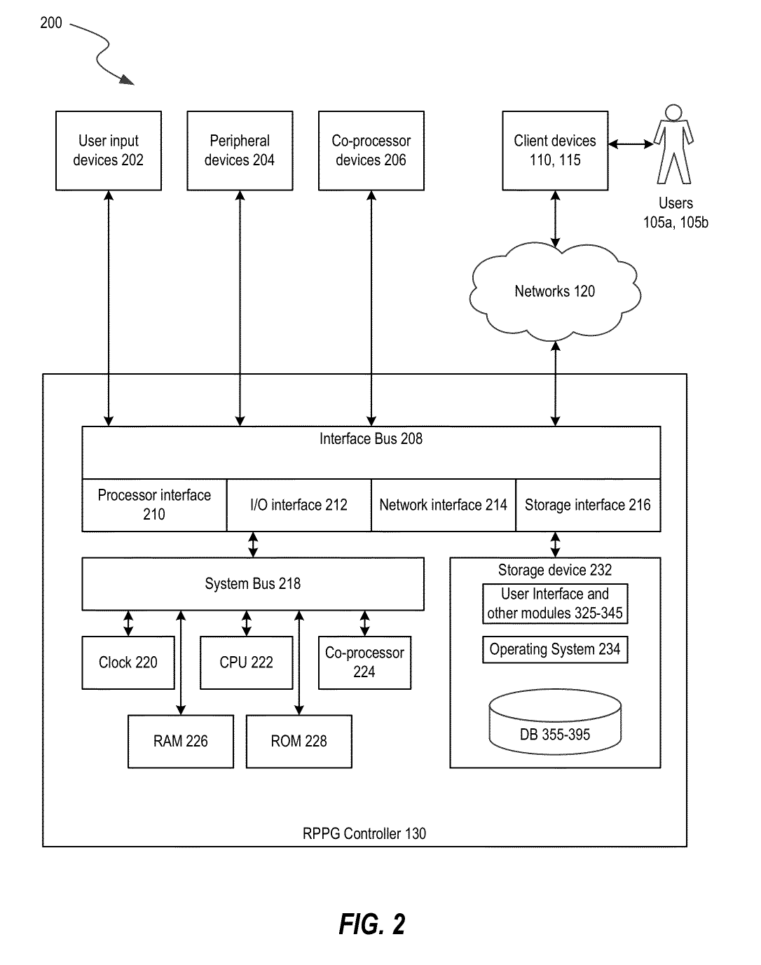

FIG. 2 is a block diagram illustrating an example embodiment of the RPPG controller system 200. The RPPG controller system 200 includes a RPPG controller 130 that may be in communication with entities including one or more users 105a, 105b, client devices 110, 115, user input devices 202, peripheral devices 204, an optional co-processor device(s) (e.g., cryptographic processor devices) 206, and networks 120. Users 105a, 105b, such as end-users, portfolio managers and other systems, may engage with the RPPG controller 130 via client devices 110, 115.

Computers employ central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

The RPPG controller 130 may include clock 220, CPU 222, memory such as read only memory (ROM) 228 and random access memory (RAM) 226 and co-processor 224 among others. These controller components may be connected to a system bus 218, and through the system bus 218 to an interface bus 208. Further, user input devices 202, peripheral devices 204, co-processor devices 206, and the like, may be connected through the interface bus 208 to the system bus 218. The Interface bus 208 may be connected to a number of interface adapters such as processor interface 210, input output interfaces (I/O) 212, network interfaces 214, storage interfaces 216, and the like.

Processor interface 210 may facilitate communication between co-processor devices 206 and co-processor 224. In one implementation, processor interface 210 may expedite encryption and decryption of requests or data. Input Output interfaces (I/O) 212 facilitate communication between user input devices 202, peripheral devices 204, co-processor devices 206, and/or the like and components of the RPPG controller 130 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 214 may be in communication with networks 120. Through networks 120, the RPPG controller 130 may be accessible to remote client devices 110, 115. Network interfaces 214 may use various wired and wireless connection protocols such as, direct connect, Ethernet, wireless connection such as IEEE 802.11a-x, and the like. Examples of networks 120 include the Internet, Local Area Network (LAN), Metropolitan Area Network (MAN), a Wide Area Network (WAN), wireless network (e.g., using Wireless Application Protocol WAP), a secured custom connection, and the like. Storage interfaces 216 may be in communication with a number of storage devices such as, storage devices 232, removable disc devices, and the like. The storage interfaces 216 may use various connection protocols such as Serial Advanced Technology Attachment (SATA), IEEE 1394, Ethernet, Universal Serial Bus (USB), and the like.

User input devices 202 and peripheral devices 204 may be connected to I/O interface 212 and potentially other interfaces, buses and/or components. User input devices 202 may include card readers, finger print readers, joysticks, keyboards, microphones, mouse, remote controls, retina readers, touch screens, sensors, and/or the like. Peripheral devices 204 may include antenna, audio devices (e.g., microphone, speakers, etc.), cameras, external processors, communication devices, radio frequency identifiers (RFIDs), scanners, printers, storage devices, transceivers, and/or the like. Co-processor devices 206 may be connected to the RPPG controller 130 through interface bus 208, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The RPPG controller 130 may employ various forms of memory including on-chip CPU memory (e.g., registers), RAM 226, ROM 228, and storage devices 232. Storage devices 232 may employ any number of tangible, non-transitory storage devices or systems such as fixed or removable magnetic disk drive, an optical drive, solid state memory devices and other processor-readable storage media. Computer-executable instructions stored in the memory may include one or more program modules such as routines, programs, objects, components, data structures, and so on that perform particular tasks or implement particular abstract data types. For example, the memory may contain operating system (OS) component 234, user interface and other modules 325-345, database tables 355-395, and the like. These components may be stored and accessed from the storage devices, including from external storage devices accessible through an interface bus.

The database components 355-395 are stored programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

The RPPG controller 130 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the RPPG may be distributed electronically over the Internet or over other networks (including wireless networks). Those skilled in the relevant art will recognize that portions of the RPPG may reside on a server computer, while corresponding portions reside on a client computer. Data structures and transmission of data particular to aspects of the RPPG are also encompassed within the scope of the invention.

### Suitable Systems

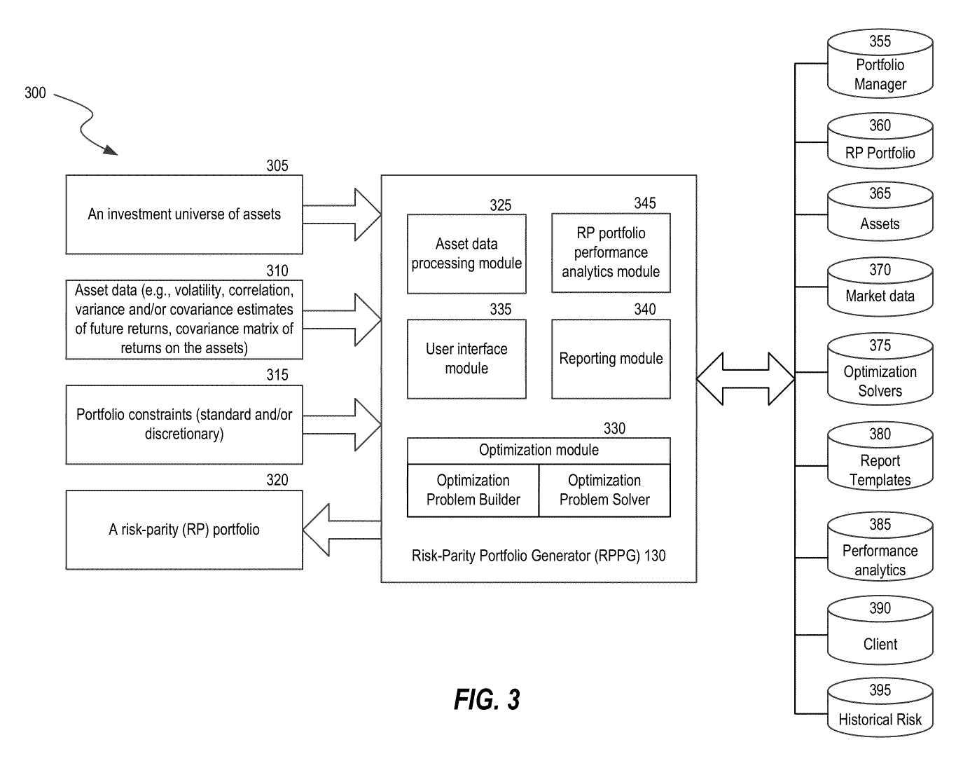

FIG. 3 is a block diagram illustrating an embodiment of the RPPG system 300. The system 300 may comprise inputs 305, 310 for processing by RPPG 130, database tables 355-395 for providing data and other computer readable instructions or program codes for RPPG 130 for processing the inputs, and outputs 320 that are generated by RPPG 130 as a result of the processing. As shown in FIG. 3, RPPG 130 may receive input 305, and input 310. Input 305 may include an investment universe of assets that are to be included in a RP portfolio. The assets may be selected by an end-user or a portfolio manager (hereinafter “portfolio manager”) constructing the RP portfolio via an RPPG user interface (e.g., an interface provided by the user interface module 335). The assets that are selected for inclusion in the RP portfolio may belong to various asset classes, such as cash and cash equivalents (e.g., certificate of deposit, money market funds), fixed interest securities (e.g., bonds, including government or corporate bonds, domestic, foreign or emerging market bonds, etc.), stocks (e.g., domestic, foreign, etc.), real estate (e.g., REITs), insurance products, derivatives, foreign currency, resources, and/or the like.

RPPG 130 may also receive as input asset data 310. Asset data 310 may include data relating to selected assets 305. Examples of asset data 310 include data corresponding to volatility or risk, correlation, variance, covariance, uncertain future returns, covariance matrix, asset type, beta, and/or the like. In some implementations, RPPG 130 (e.g., using asset data processing module 325) may compute covariance matrix of the assets using historical risk data. In some implementations, asset data may be retrieved from a database table (e.g., market data table 370) that is maintained in-house (e.g., by investment bank). Alternatively, market data table 370 may be populated through one or more market data feed such as Bloomberg's PhatPipe, Triach, and the like. In some other implementations, covariance matrix may be the only asset data necessary for constructing an RP portfolio.

Portfolio constraints 315, either standard and/or discretionary, may also be supplied as input to RPPG 130. In some implementations, a default portfolio constraint may be applied in the absence of or in addition to other constraints supplied by the user. A default constraint may include, for example, a no shorting restriction. A long position in a security will result in profit if the price of the security goes up. In other implementations, weight constraints on the portfolio component weights may be applied to the RP portfolio. Weight constraints may include an upper bound, a lower bound, or a combination of upper and lower bounds on the weight of each asset class represented in the RP portfolio. In one implementation, the lower bound on a portfolio component weight may be required to be at least zero, and no less. Other constraints that may be applied to the RP portfolio include a target value for the sum of the portfolio component weights. For example, sum of the portfolio component weights may be required to equal 100%, or some other positive quantity less than 100%, to allow for a cash buffer in the portfolio.

RPPG 130 may include one or more modules, including, but not limited to: an asset data processing module 325, an optimization module 330, a user interface module 335, a reporting module 340 and an RP portfolio performance analytics module 345. In some implementations, one or more of these modules may be consolidated into a single module. In some instances, implementation of one or more of these modules may be made optional. Asset data processing module 325 may include computer-executable instructions for processing data relating to assets (e.g., assets 305). For example, module 325 may obtain or utilize historical risk data to determine covariance matrix of the assets, which is then provided to the optimization module 330. In instances where the covariance matrix of the assets is available as an input, implementation of asset data processing module 325 may not be desired.

Optimization module 330 may include computer-executable instructions for utilizing asset data such as covariance matrix as an input to an optimization problem to solve for a RP portfolio solution. The optimization module 330 may include two sub-modules, namely an optimization problem builder and an optimization problem solver. The optimization problem builder may formulate an optimization problem by applying homogenized portfolio constraints to an objective function. The optimization problem solver may apply initial conditions to solve the formulated optimization problem to generate an RP portfolio having equal or approximately equal risk contribution from portfolio asset components.

User interface module 335 may include a graphical user interface that allows for the display, execution, interaction, and/or operation of program modules and other facilities through various facilities. User interface module 335 may communicate with operating systems, other program modules such as the optimization module 330 and the reporting module 340, among others to communicate, generate and/or receive requests, responses and other data.

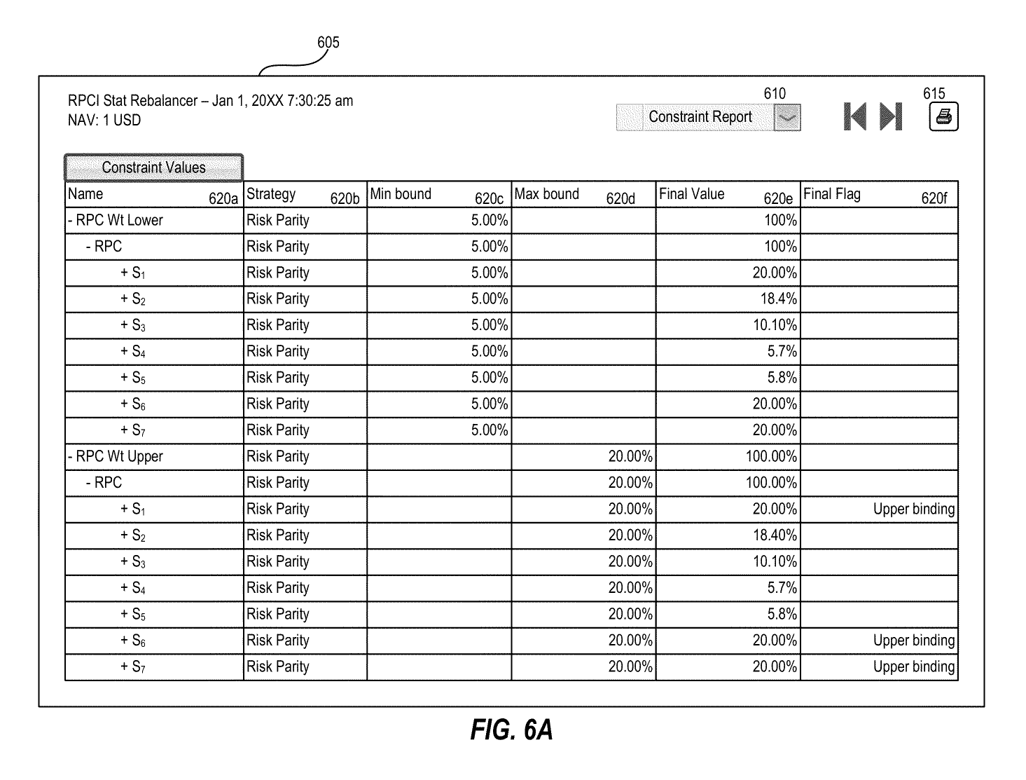

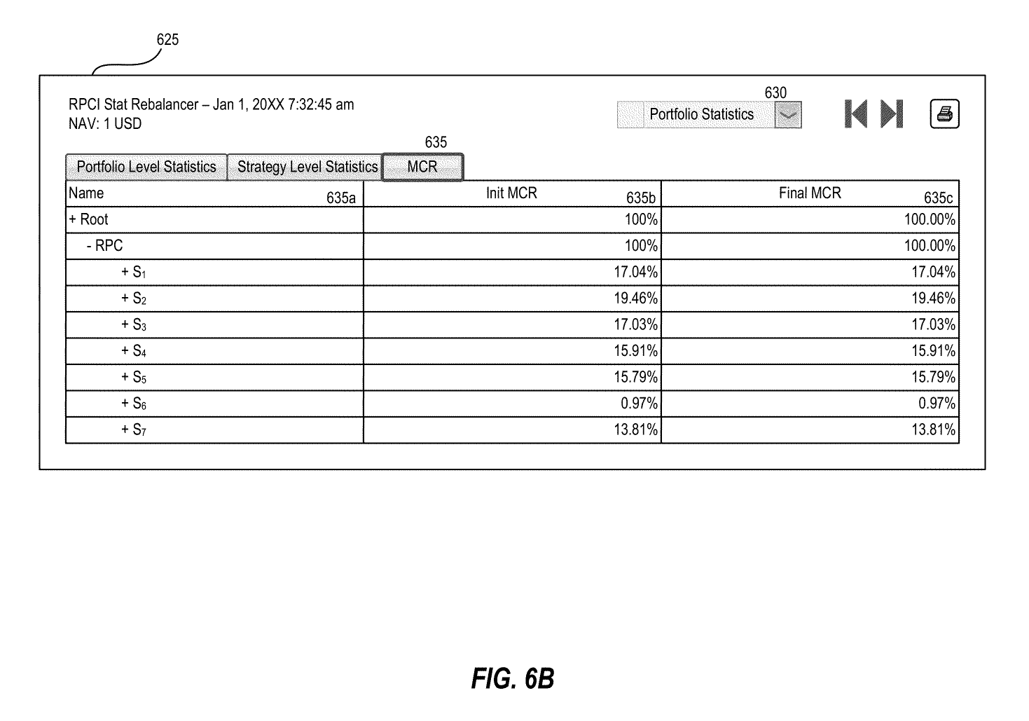

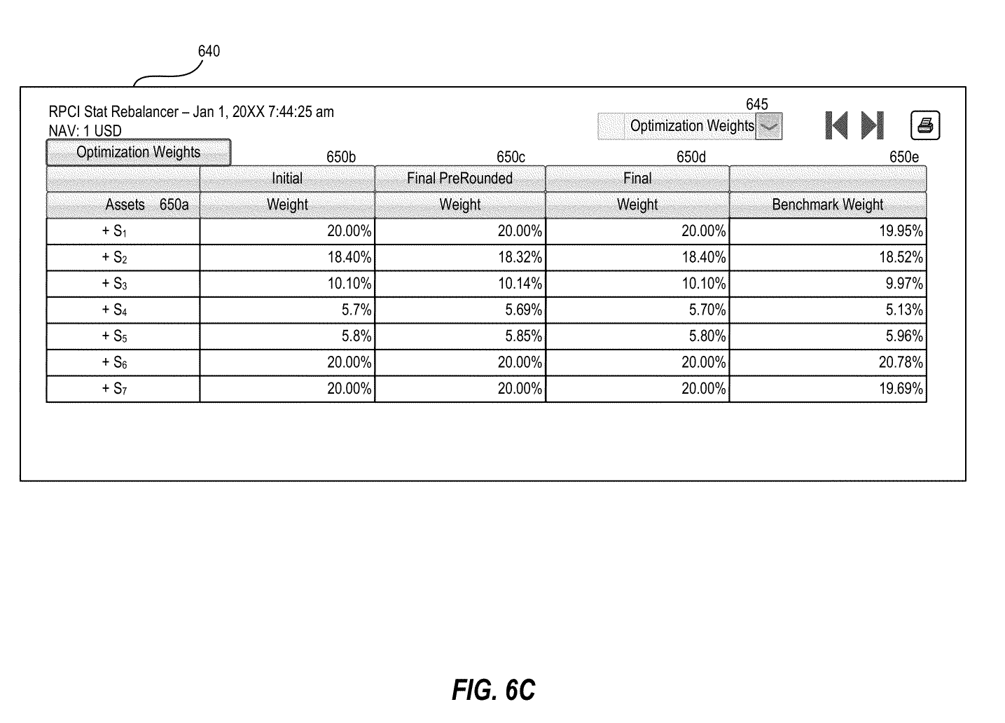

Reporting module 340 may include computer-executable instructions for using input data and data obtained from other modules to generate reports, charts, tables and the like. Such reports may be customized, formatted, and sent to requesting users via communication channels such as email, printed or published privately or publicly on a website or a portal. Example user interfaces for reporting are discussed in detail with respect to FIGS. 6A-C.

Performance analytics module 345 may include computer-executable instructions for tracking the performance of a RP portfolio over time. By tracking the performance of the RP portfolio, module 345 may determine whether the RP portfolio should undergo reallocation. Alternatively, performance analytics module 345 may automatically, on a periodic basis, reallocate the portfolio assets. Such reallocation, performance based or otherwise, may assist in ensuring that the risk contributions from the portfolio assets are balanced or substantially balanced.

RPPG 130 may be in communication with one or more database tables such as a portfolio manager table 355, RP portfolio table 360, assets table 365, market data table 370, optimization solvers table 375, report templates table 380, performance analytics table 385, client table 390, and historical risk data table 395. In some implementations, one or more of these database tables may be consolidated. Portfolio manager table 355 may include data fields such as portfolio manager ID, name, fund amount, RP portfolio ID, client ID, and the like. RP portfolio table 360 may include RP portfolio ID, asset ID, risk contribution, funds allocation, constraints, solver ID, initial conditions, client ID, contribution date, reallocation date, and the like. Assets table 365 may include fields such as asset ID, asset name, risk, returns, and the like. Market data 370 may include fields such as asset ID, value, % change, and the like. Optimization solvers table 375 may include fields such as solver ID, solver name, and the like. Report templates table 380 may include fields such as template ID, chart type, and the like. Performance analytics table 385 may include fields such as RP portfolio ID, returns, date, % change, reallocation date, reallocation frequency, and the like. Client 385 may include fields such as a client ID, client name, client address, funds amount, RP portfolio ID, preferences, and the like. Historical risk table 395 may include fields such as asset ID, returns, time period, or the like.

### Formulation of RP Portfolio Optimization Problem

An RP portfolio comprises of an investment universe of n assets S₁,S₂, . . . , Sₙ with uncertain future returns r₁,r₂, . . . , rₙ. Suppose r=[r₁,r₂, . . . , rₙ]^{T} is a vector of these returns. A portfolio is represented with an n-dimensional vector ω=[ω₁, . . . , ωₙ)]^{T}, where ωᵢ denotes the proportion of the total funds invested in security i. Suppose Ω, a subset of Rⁿ denotes the set of permissible portfolios. The uncertain return of the portfolio, rₚ, depends linearly on the weights:

rₚ(ω)=ω₁r₁+ . . . +ωₙrₙ=ω^{T}r (1)

Suppose σᵢ denotes the standard deviation of the return rᵢ of asset Sᵢ. For i≠j, suppose ρᵢⱼ denotes the correlation coefficient of the returns of assets Sᵢ and Sⱼ. Suppose,

$$\sum = [ \begin{matrix}{σ}_{11} & {σ}_{12} & … & {σ}_{1 n} \\ {σ}_{21} & {σ}_{22} & … & {σ}_{2 n} \\ ⋮ & ⋮ & ⋮ & ⋮ \\ {σ}_{n 1} & {σ}_{n 2} & … & {σ}_{nn}\end{matrix} ] \qquad ( 2 )$$

Σ is a symmetric n×n covariance matrix of the returns with σᵢᵢσᵢ² and σᵢⱼ=σⱼᵢ=ρᵢⱼσᵢσⱼ for i≠j. All valid covariance matrices are positive semidefinite matrices, that is, all of their eigenvalues are non-negative. The covariance matrix is assumed to be positive definite, that is, ω^{T}Σω>0 for all ω≠0. In other words, none of the assets S₁,S₂, . . . , Sₙ can be perfectly replicated by a combination of remaining assets.

### Risk Contributions

For a given portfolio ω, the standard deviation of the portfolio return may be used as a measure of risk of the portfolio. The standard deviation may be calculated in accordance with:

σ(ω)=\sqrt{ω^{T}Σω} (3)

In portfolio management, contributions of individual components to the total portfolio risk are generally quantified. The distribution of risk contributions from different portfolio components may then be used to measure the level of diversification within the portfolio. There are different ways to define the risk contribution of an individual position to a portfolio. For example, the difference between the risk measures of the existing portfolio and the portfolio that is obtained by removing one of the positions may be defined as the risk contribution of the position that was removed. This approach is outlined in CreditMetrics, Technical Document, J. P. Morgan, 1997, which is hereby expressly incorporated by reference. However, this definition of the risk contribution has the property that the sum of the contributions across all the portfolio positions does not generally equal the total portfolio risk, thus making the interpretation of the risk contributions to be unintuitive.

An alternative definition of risk contribution may then be used which defines the marginal risk contribution (MRC) of asset i, as the partial derivative of the function σ(ω) with respect to ωᵢ this is the rate of change in the portfolio. The partial derivative, that is, the rate of change in the portfolio risk as the weight of asset i increases may be expressed as:

$${MRC}_{i} ( ω ) = \frac{\partial σ ( ω )}{\partial {ω}_{i}} = \frac{{( Σω )}_{i}}{σ ( ω )} \qquad ( 4 )$$

Above, (Σω)ᵢ=Σⱼ₌₁ⁿσᵢⱼωⱼ is the i-th component of the vector Σω. The risk contribution (RC) of asset i is defined as the product of its weight and its MRC in accordance with:

$${RC}_{i} ( ω ) = {ω}_{i} \cdot {MRC}_{i} ( ω ) = \frac{{ω}_{i} \cdot {( Σω )}_{i}}{σ ( ω )} \qquad ( 5 )$$

An important property of this definition is that the sum of the risk contributions for all assets in the portfolio is the total risk of the portfolio:

$${\sum }_{i = 1}^{n} {RC}_{i} ( ω ) = {\sum }_{i = 1}^{n} \frac{{ω}_{i} \cdot {( Σω )}_{i}}{σ ( ω )} = \frac{{ω}^{T} Σω}{σ ( ω )} = σ ( ω ) \qquad ( 6 )$$

### Risk Parity

Given an n-dimensional covariance matrix Σ, a portfolio ω=[ω₁, . . . , ωₙ]^{T} is a RP portfolio with respect to the covariance matrix if it satisfies the following condition:

$${RC}_{i} ( ω ) = \frac{σ ( ω )}{n} , i = 1 , … , n \qquad ( 7 )$$

The relative risk contribution (RRC) of an asset is defined as the ratio of its risk contribution to the total portfolio risk in accordance with:

$${RRC}_{i} ( ω ) = \frac{{RC}_{i} ( ω )}{σ ( ω )} = \frac{{ω}_{i} \cdot ( Σω )}{{σ}^{2} ( ω )} = \frac{{ω}_{i} \cdot {( Σω )}_{i}}{{ω}^{T} Σω} \qquad ( 8 )$$

Portfolio ω is a RP portfolio if and only if:

$${RRC}_{i} ( ω ) = \frac{1}{n} , i = 1 , … , n \qquad ( 9 )$$

### Long-Only Risk Parity

A portfolio manager may desire to build a portfolio that satisfies the requirements of the client, regulatory restrictions, and discretionary views of the portfolio manager. Such restrictions may be represented as mathematical constraints. Example restrictions may include, for example, maintaining long-only investments and having a full investment where the sum of the investment weights equals 1, or having a portfolio with a pre-specified amount of uninvested cash holding.

A fully-invested long-only RP portfolio is a portfolio that satisfies ωᵢ≧0, ∀i, Σᵢ₌₁ⁿωᵢ=1, while also satisfying (7). An exemplary optimization problem for constructing a long-only RP portfolio using the methods and systems described herein is provided below:

$${min}_{x > 0} f ( x ) \text{:} = {x}^{T} Σ x - {\sum }_{i = 1}^{n} ln {x}_{i} \qquad ( 10 )$$

The domain of the objective function f for problem (10) is the interior of the nonnegative orthant [symbol] ₋ⁿ:={x:x≧0}. The optimization problem (10) is unconstrained in its domain. The optimization problem (10) may be referred to as the logarithmic penalty formulation since the term

$$- {\sum }_{i = 1}^{n} ln {x}_{i}$$

is the logarithmic barrier (or logarithmic penalty) function for the nonnegative orthant [symbol] ₊ⁿ.

The optimality conditions for the optimization problem (10) is given by the following:

∇f(x)=2Σx−x⁻¹=0 (11)

### Where,

$${x}^{- 1} = {[ \frac{1}{{x}_{1}} , … , \frac{1}{{x}_{n}} ]}^{T}$$

is the vector of reciprocals of the vector x. Each element of (11) can be written equivalently as:

$$2 {( Σ x )}_{i} - \frac{1}{{x}^{i}} = 0 , ⇔ {x}_{i} \cdot {( Σ x )}_{i} = \frac{1}{2} , i = 1 , … , n \qquad ( 12 )$$

The optimization problem (10) has several important properties that make it suitable for construction of RP portfolios. For example, f(x) is a strictly convex function of x, and as a consequence, any local minimizer of f is also a global minimizer. Furthermore, because of the strict convexity of f, whenever a minimizer exists, it is also unique. The covariance matrix is assumed to be a positive definite matrix, such that f(x) is bounded below over [symbol] ₊ⁿ. A strictly convex and continuous function that is bounded below achieves its minimum value and the minimizer is unique. Consequently, f has a unique minimizer on [symbol] ₊ⁿ and this solution corresponds to a unique RP portfolio over the set {ω∈ [symbol] ₊ⁿ:ω≧0, Σᵢ₌₁ⁿωᵢ=1}.

The optimization problem (10) does not have a full investment constraint (Σᵢxᵢ=1). As a result, the optimal solution of the problem (10), defined as x*, is not necessarily a valid or desirable portfolio. In order to obtain a valid portfolio, the optimal solution x* may be scaled. Suppose, γ=Σᵢxᵢ*, then the optimal solution may be scaled in accordance with:

$$ω = \frac{1}{γ} {x}^{*} \qquad ( 13 )$$

By verifying that ω≧0 and Σᵢωᵢ=1, the portfolio ω may be proved to be a fully invested long-only portfolio. Furthermore, for i=1, . . . , n, the relative risk contribution of the portfolio may be shown to satisfy (9) as shown:

$${RRC}_{i} ( ω ) = \frac{{{ω}_{i} ( Σ ω )}_{i}}{{ω}^{T} Σ ω} = \frac{\frac{1}{{γ}^{2}} {x}_{i}^{*} \cdot {( Σ {x}^{*} )}_{i}}{\frac{1}{{γ}^{2} {\sum }_{i = 1}^{n} {x}_{i}^{*} \cdot {( Σ {x}^{*} )}_{i}}} = \frac{\frac{1}{{γ}^{2}} \cdot \frac{1}{2}}{\frac{1}{{γ}^{2}} \cdot \frac{n}{2}} = \frac{1}{n} \qquad ( 14 )$$

Consequently, a portfolio constructed using the exemplary optimization problem (10) is a RP portfolio. Instead of defining RP portfolios by a specific property, a RP portfolio defined in terms of the optimal solution of the problem (10) provides an implicit characterization of risk parity. This exemplary characterization provides an efficient recipe for building fully invested long-only RP portfolios, whereby problem (10) is first solved numerically and its solution scaled so that the weights sum to 1.

### Approximate RP Portfolio

As previously discussed, a portfolio manager may desire to build a portfolio that satisfies the requirements of the client, regulatory restrictions, and discretionary views of the portfolio manager and those restrictions may be represented as mathematical constraints. Formulation of a RP optimization problem with restrictions relating to maintaining long-only investments and having a full investment where the sum of the investment weights equals 1 has been discussed. When building portfolios, a portfolio manager may have multiple and possibly conflicting objectives, in addition to the long-only position. This may be the case for building diversified portfolios, for example. RP portfolios seek balanced allocations of the risk budget, as opposed to the weights, to different sources of risk. A portfolio manager desiring to combine some of these objectives to build a portfolio that allocates the risk budget as well as the capital equitably over multiple assets may find the task impossible, with the two objectives being in conflict. For example, in a scenario where portfolio manager tries to allocate weights to stocks and bonds, if he or she were to assume that stocks are much riskier than bonds, an equal weights allocation would yield a portfolio where most of the risk comes from the equity position. In contrast, a risk parity allocation would allocate most of the capital to the bonds. A compromise may be achieved by seeking approximate risk parity, where deviations from risk parity are allowed but undesired, while at the same time limits may be placed on position weights to discourage too much or too little capital allocation to any single asset class. The competing objectives of balanced capital and risk allocation may be addressed by utilizing the implicit characterization of risk parity as previously discussed with respect to optimization problem (10). An approximate RP portfolio may be characterized as a solution to an optimization problem in accordance with:

$${min}_{x} {x}^{T} Σ x - {\sum }_{i = 1}^{n} ln {x}_{i} \\ x \geq \frac{1}{θ} ( {\sum }_{i = 1}^{n} {x}_{i} ) \cdot l \\ x \leq \frac{1}{θ} ( {\sum }_{i = 1}^{n} {x}_{i} ) \cdot u \qquad ( 15 )$$

where, the upper bound u and the lower bound l are homogenized bound constraints and θ is a positive constant, representing the pre-determined proportion of the funds available to be invested in the portfolio. In one implementation, the positive constant may be no more than 1. Since the homogenized bound constraints are linear, they may be handled efficiently by an optimization software. The homogenization of the bound constraints may rely on the following identity:

$$\{ y ∈ {ℜ}^{n} \text{:} {\sum }_{i = 1}^{n} {y}_{i} = θ , l \leq y \leq u \} = \{ y ∈ {ℜ}^{n} \text{:} y = \frac{θ \cdot x}{{\sum }_{i = 1}^{n} {x}_{i}} , ( \frac{{\sum }_{i = 1}^{n} {x}_{i}}{θ} ) \cdot l \leq x \leq ( \frac{{\sum }_{i = 1}^{n} {x}_{i}}{θ} ) \cdot u , {\sum }_{i = 1}^{n} {x}_{i} > 0 \} \qquad ( 16 )$$

As in the case of optimization problem (10), optimization problem (15) has a strictly convex objective function, and has a unique solution. Any solver algorithm that converges to a local solution will produce the only global solution of the problem. Furthermore, the solutions from optimization problem (15) are good approximations of true risk parity.

### Example Processing

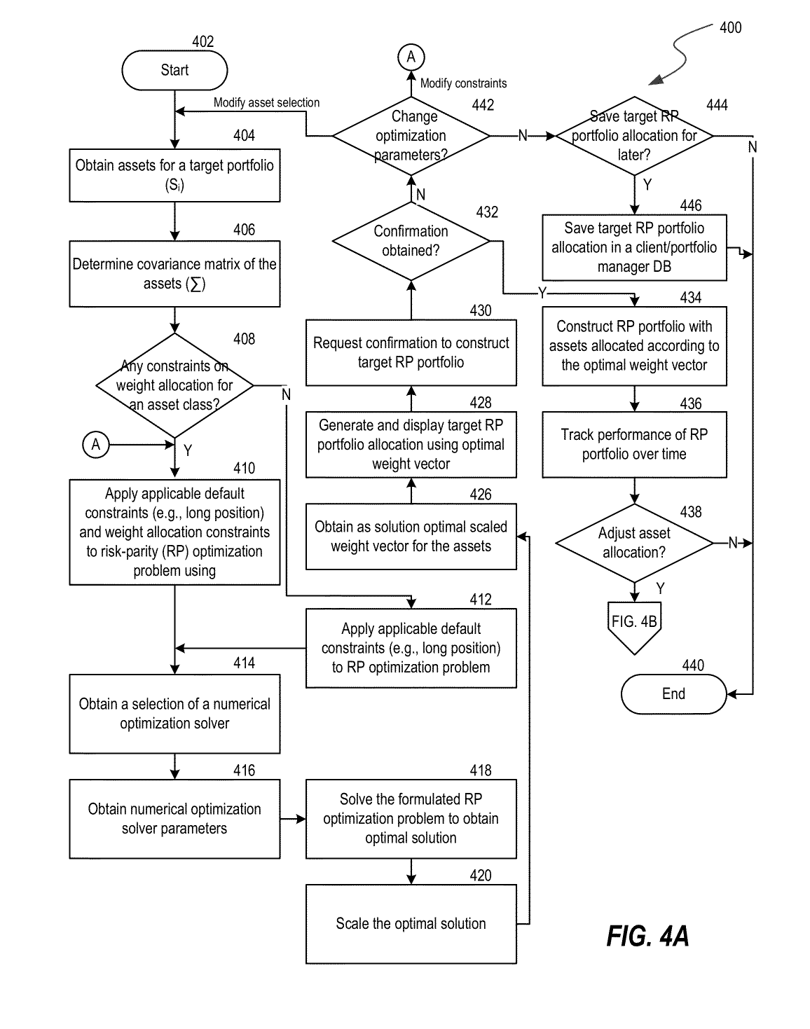

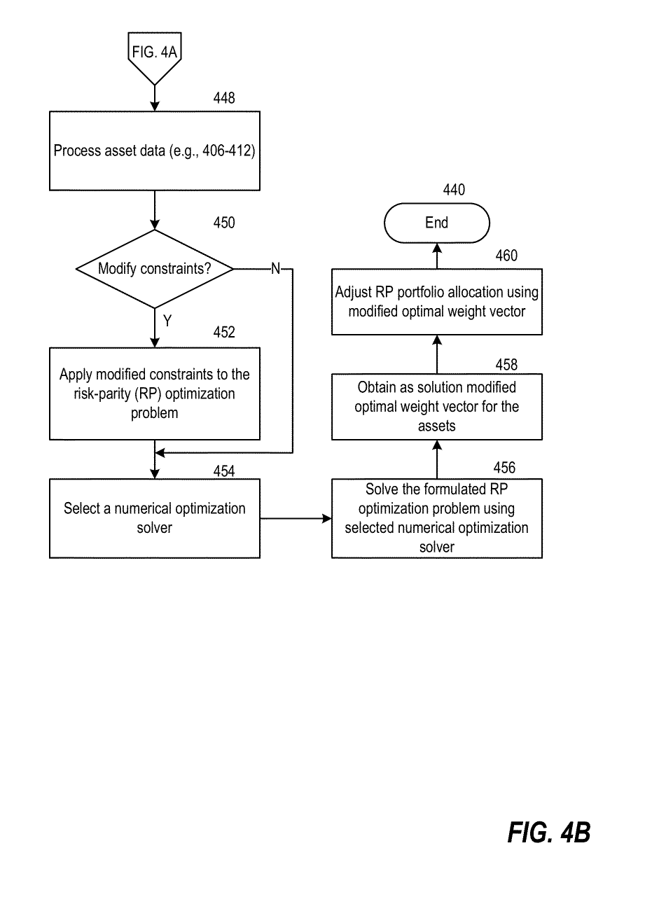

FIGS. 4A-B are logic flow diagrams illustrating construction of a RP portfolio. Starting at 402, a selection of assets for a target RP portfolio may be obtained. The selection may be made by a portfolio manager, and may include assets representing various asset classes. Any number of assets may be selected, as desired, for inclusion in the target RP portfolio. At 406, the covariance matrix for the selected assets may be obtained. As previously discussed, in some implementations, the covariance matrix may be calculated using historical risk data. In other implementations, covariance matrix may be supplied as an input. At 408, the RPPG may determine if there are any constraints on weight allocation for an asset in the target portfolio. If there are weight allocation constraints, at 410, the weight constraints and the default constraints (e.g., long position) may be applied to optimization problem (15). The weight allocation, as previously discussed, may include an upper bound, a lower bound, or both upper and lower bounds on the weight of each asset in the target portfolio. In some implementations, a constraint on the proportion of funds available for investment in the portfolio may be applied to optimization problem (15). At 408, if there are no constraints on the target RP portfolio, the RPPG may apply the default constraints to optimization problem (10) at 412. At 414, a selection of a numerical optimization solver may be obtained to numerically solve the optimization problem with applied constraints. The solver may be a function available in commercial packages such as MATLAB's optimization toolbox (e.g., fmincon function), IMSL Optimization Library (e.g., min_con_gen_lin and constrained_nlp functions) and the like. At 416, solver parameters such as initial condition, termination condition, gradient function, and the like, may be obtained. In some implementations, default values for these solver parameters may be utilized. At 418, once the solver is set up with the solver parameters, RP optimization problem 10 or 15 may be solved using the selected numerical solver. The solving of the optimization problem may generate an optimal solution. As previously discussed, the optimal solution is a unique solution. Furthermore, the unique solution may be an exact solution, or an approximate solution within the accuracy limitations of the processor solving the optimization problem. For example, the true unique solution may be π, but the processor may generate an approximate solution of 3.1416. In some implementations, the solutions may also be rounded up or down as desired.

The optimal solution generated at 418 may not necessarily be a valid or desirable RP portfolio. In order to obtain an optimal solution that is a valid or desirable RP portfolio, the optimal solution may be scaled at 420. The scaling may rely upon the relationship between the variable that is optimized and the weight component in accordance with (13). At 426, an optimal scaled solution representing optimal weight vector for the assets may be obtained. It should be noted that in the presence of additional constraints (e.g., component weight constraints), the optimal solution corresponds to an approximate RP portfolio. For the approximate RP portfolio, depending on the list of assets in the asset universe and the divergence in their individual risk characteristics, maximum deviation from parity can range from zero or a small quantity, to nearly the quantity obtained by dividing 1 by the number of assets in the investment universe.

At 428, allocations for the target RP portfolio may be generated based on the optimal weight vector, and may be displayed to the portfolio manager for confirmation. At 430, confirmation to construct the target portfolio may be requested. If the confirmation is obtained at 432, the target RP portfolio may be constructed at 434 by allocating assets according to the optimal weight vector solution. Alternatively, if a confirmation is not obtained, at 442, the RPPG may determine if the portfolio manager desires to modify any optimization parameters. If the portfolio manager desires to modify the asset selection for the target portfolio, the RPPG may obtain a new set of user-selected assets for a target RP portfolio at 404. If the portfolio manager desires to modify the applied RP portfolio constraints, the RPPG may obtain new or modified constraints specified by the portfolio manager, and at 410, may apply the modified constraints to the RP optimization problem. In some instances, the portfolio manager may not desire to make any modifications to the optimization parameters, in which case, the decision moves to 444. At 444, if the portfolio manager wishes to save the target RP portfolio for construction at a later time, the target RP portfolio, along with the applied constraints, solver and solver conditions, optimal weight vector solution, and other fields of information may be saved at a user-specified location (e.g., in the RP portfolio table 360) at 446, after which the process concludes at 440. The portfolio manager may then retrieve the target RP portfolio at a later time, and complete the construction. Alternatively, if the portfolio manager wishes to not save the target RP portfolio, the process concludes at 440.

In one implementation, the RP portfolio that is constructed at 434 may be used as an index portfolio. Indexed portfolios are passively managed portfolios. The RP index portfolio may be used as a benchmark to provide a starting point for portfolio managers to construct other actively managed RP portfolios, and compare such actively managed RP portfolio performance against that of the index RP portfolio. For example, if the annual return of the index RP portfolio is 7%, a portfolio manager may gauge the performance of his or her managed RP portfolio having an annual return of 8.5% with respect to that of the index and determine that his or her RP portfolio has outperformed the index. The RPPG may also be used to construct managed RP portfolios.

After constructing the RP portfolio at 434, the RPPG may undergo periodic reallocation of the asset weights in the portfolio. In one implementation, the periodic reallocation may be performance based. At 436, the RPPG may track the performance of the RP portfolio over time, and at 438 determine whether a reallocation is necessary. In one implementation, this determination may be based on one or more criteria such as portfolio returns, user's desire, and the like. Referring now to FIG. 4B, if the asset weights are to be reallocated, updated asset data (e.g., covariance matrix) may be obtained at 448. At 450, the RPPG may determine whether the constraints are to be modified (e.g., based on user input), and if they are to be modified, the RPPG may apply the modified constraints to the RP optimization problem at 452. Alternatively, if there are no modifications to the previously applied constraint, a numerical optimization solver may be selected at 454 for solving the optimization problem having the modified constraints. The selected solver may be the same solver that was used previously or may be a new solver specified by the user. Solver parameters, with or without modification from the ones previously used, may also be supplied or obtained at 454. At 456, the optimization problem may be solved using the selected solver having the specified solver parameters. At 458, the optimal solution may be obtained and scaled appropriately to generate optimal weight vector solution. The generated scaled solution may then be used to adjust the asset allocations in the RP portfolio at 460, concluding the asset reallocation process at 440.

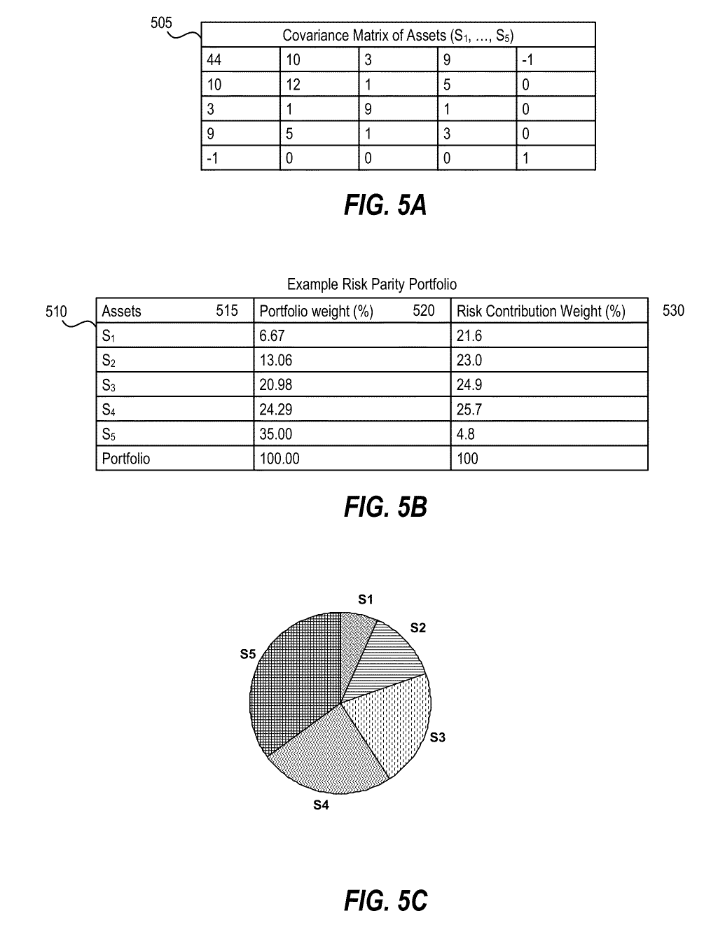

FIG. 5A is a table illustrating example covariance matrix of assets S₁, S₂, S₃, S₄ and S₅. The covariance matrix 505 of the assets may be supplied as an input to the RPPG. The RPPG may use the covariance matrix 505 to solve for an optimal weight vector solution that satisfies the applied constraints, and achieves a balanced risk contribution. FIG. 5B is a table illustrating an example RP portfolio including assets with the covariance matrix 505. The table 510 includes a first column of assets 515 (S₁, S₂, S₃, S₄ and S₅), a second column of portfolio weight (%) 520 and a third column of risk contribution weight (%) 530. The portfolio weight 520 is the optimal scaled weight vector solution obtained from the RPPG as a result of solving the optimization problem under the constraint that required the portfolio component weight be between 5% and 35% inclusive. As shown, column 520 lists portfolio weights that are within the constraints specified.

The risk contribution weight listed in column 530 is the value that the RPPG seeks to balance. In the example RP portfolio, for the given constraints on the portfolio component weights, the optimal risk contribution from assets S1 through S5 was determined to be 21.6%, 23.0%, 24.9%, 25.7% and 4.8% respectively. Although the risk contribution in this example is not equal across all the assets in the RP portfolio, it is nevertheless an optimal solution under the given constraints. This solution minimizes the deviation from true risk parity, and is example of an approximate RP portfolio that seeks to balance or substantially balance the risk contribution from each asset component of the portfolio, given the constraints. FIG. 5C is a graphical representation of the example RP portfolio, wherein each sector is representative of the portfolio component weight of the corresponding asset.

### Example User Interfaces

As previously discussed, embodiments of the RPPG may include modules and facilities for processing reports and displaying such reports via graphical user interfaces. The graphical user interfaces shown in FIGS. 6A-C illustrate three types of reports generated by the RPPG. FIG. 6A is an example graphical user interface of a constraint report. Graphical user interface 605 may be generated upon selection of constraint report option 610 from a drop down menu. The constraint report shows the bounds applied to each asset class, final weight, and the status of the bound (i.e., whether the bound is binding or not). The constraint report may include various fields of information including name 620a (e.g., asset name), strategy 620b (e.g., RP), minimum bound 620c, maximum bound 620d, final value 620e and a final flag 620f (e.g., binding status). The graphical user interface may include a print icon 615 for printing, and/or other options for email, publication, download, export, and/or the like.

FIG. 6B is an example graphical user interface of a marginal contribution to risk (MCR) report. Graphical user interface 625 may be displayed when an option for portfolio statistics is selected from a drop down menu 630. Several tabs may be displayed to view statistics relating to the portfolio, strategy and MCR. When the MCR tab 635 is selected, the MCR report may be displayed showing the risk contribution levels for each asset class. The assets are listed in column 635a, initial MCR values are listed in column 635b, and final MCR values are listed in column 635c.

FIG. 6C is an example graphical user interface of an optimal weight report. Graphical user interface 640 may be displayed when an option for optimization weights is selected from a drop down menu 645. The optimal weight report may show the weights of each asset class. As shown, assets are listed in column 650a, initial weights before optimization are listed in column 650b, final pre-rounded weights after optimization are listed in column 650c and final weights (after rounding) are listed in column 650d. The optimal weight report may include additional fields such as benchmark weight 650e which may include a list of weights corresponding to a benchmark RP portfolio. Other types and forms of reports and graphical user interfaces are contemplated and are within the scope of this application.

### CONCLUSION

The above Detailed Description of embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

We claim:

1. A processor-implemented method of constructing a portfolio, comprising:
receiving a selection of investment components for inclusion in a risk parity portfolio;
receiving upper and lower limits on each investment component weight;
determining, by the processor, a solution corresponding to optimal investment component weights, wherein each optimal investment component weight is within the upper and lower limits, and the sum of the optimal investment component weights is equal to a specified target; and
constructing the risk parity portfolio having the investment components configured in accordance with the optimal investment component weights, such that each investment component in the risk parity portfolio contributes an approximately equal amount of financial risk.

2. The method of claim 1, further comprising:
receiving the specified target, wherein the specified target represents a proportion of available funds to be invested in the risk parity portfolio.

3. The method of claim 2, wherein the determining further comprises:
constraining a convex optimization problem with the upper and lower limits on each investment component weight; and
solving, by the processor, the convex optimization problem to determine an intermediate solution.

4. The method of claim 3, further comprising:
scaling the intermediate solution to derive the solution corresponding to the optimal investment component weights.

5. The method of claim 3, wherein the convex optimization problem is further constrained by requiring only long positions on the investment components.

6. The method of claim 3, further comprising:
obtaining a covariance matrix of the investment components and providing the covariance matrix as an input to the convex optimization problem, wherein the convex optimization problem is of the form:
$$f ( x ) = {x}^{T} Σ x - {\sum }_{i = 1}^{n} ln {x}_{i}$$
$$x \geq \frac{1}{θ} ( {\sum }_{i = 1}^{n} {x}_{i} ) \cdot l$$
$$x \leq \frac{1}{θ} ( {\sum }_{i = 1}^{n} {x}_{i} ) \cdot u$$
where, x is the variable for optimization, i is an investment component from the n investment components in the risk parity portfolio, l is the lower limit, u is the upper limit, Σ is a covariance matrix and θ is a positive quantity that represents the proportion of the available funds to be invested in the risk parity portfolio.

7. The method of claim 6, wherein the solution corresponding to the optimal investment component weights is derived from the intermediate solution in accordance with:
$$ω = \frac{θ}{{\sum }_{i} {x}_{i}^{*}} {x}^{*}$$
where x* is the intermediate solution and ω is the vector of optimal investment component weights.

8. The method of claim 1, wherein the investment components include assets.

9. The method of claim 1, wherein each investment component weight specifies a proportion of the total funds for investment in the corresponding investment component.

10. The method of claim 1, wherein the financial risk contribution (RC) of each investment component (i), having a component weight (ωᵢ) in the risk parity portfolio represented as an n-dimensional vector (ω=[ω₁, . . . , ωₙ)]^{T}) is determined using:
$${RC}_{i} ( ω ) = \frac{{ω}_{i} \cdot {( Σ ω )}_{i}}{σ ( ω )}$$
wherein, σ(ω) is the risk of the risk parity portfolio and Σ is a covariance matrix.

11. A processor-implemented method of generating a portfolio, comprising:
receiving a list of assets;
obtaining a covariance matrix of the assets;
minimizing, using the processor, a convex optimization problem bounded by an upper limit (u) and a lower limit (l) to obtain an intermediate solution;
scaling the intermediate solution to determine optimal weightings for each asset; and
generating an approximate risk parity portfolio including the list of assets, each asset being allocated a portion of the total investment funds according to the corresponding optimal weighting.

12. The method of claim 11, wherein the list of assets includes assets selected from stocks, fixed income securities, cash or cash equivalents, commercial or real estate, insurance products, derivatives and foreign currency.

13. The method of claim 12, wherein the financial risk contribution (RC) of each asset (i), having a weighting (ωᵢ) in the approximate risk parity portfolio represented as an n-dimensional vector (ω=[ω₁, . . . , ωₙ)]^{T}) is determined using:
$${RC}_{i} ( ω ) = \frac{{ω}_{i} \cdot {( Σ ω )}_{i}}{σ ( ω )}$$
wherein, σ(ω) is the risk of the approximate risk parity portfolio.

14. The method of claim 11, wherein the intermediate solution is scaled in accordance with:
$$ω = \frac{1}{{\sum }_{i} {x}_{i}^{*}} {x}^{*}$$
where x* is the intermediate solution and ω is the optimal weighting.

15. The method of claim 11, wherein the convex optimization problem is defined as:
f(x)=x^{T}Σx−Σᵢ₌₁ⁿ ln xᵢ
where, x is the variable for optimization, i is an asset, and Σ is the covariance matrix.

16. A system for constructing a portfolio, comprising:
a memory;
a processor disposed in communication with the memory, and configured to issue a plurality of processing instructions stored in the memory, wherein the processor processes instructions to:
receive a selection of investment components for inclusion in a risk parity portfolio;
obtain upper and lower limits on each investment component weight;
determine a solution corresponding to optimal investment component weights, wherein each optimal investment component weight is within the upper and lower limits, and the sum of the optimal investment component weights is equal to a specified target; and
construct the risk parity portfolio having the investment components configured in accordance with the optimal investment component weights, such that each investment component in the risk parity portfolio contributes an approximately equal amount of financial risk.

17. The system of claim 16, further comprising instructions to:
receive the specified target, wherein the specified target represents a proportion of available funds to be invested in the risk parity portfolio.

18. The system of claim 17, wherein the instructions to determine the solution further comprise instructions to:
constrain a convex optimization problem with the upper and lower limits on each investment component weight; and
solve the convex optimization problem to determine an intermediate solution.

19. The system of claim 18, wherein the processor processes further instructions to:
scale the intermediate solution to derive the solution corresponding to the optimal investment component weights.

20. The system of claim 18, wherein the convex optimization problem is further constrained by long position on the investment components.

21. The system of claim 18, wherein the processor processes further instructions to:
obtain covariance matrix of the investment components and provide the covariance matrix as an input to the convex optimization problem, wherein the convex optimization problem is of the form:
$$f ( x ) = {x}^{T} Σ x - {\sum }_{i = 1}^{n} ln {x}_{i}$$
$$x \geq \frac{1}{θ} ( {\sum }_{i = 1}^{n} {x}_{i} ) \cdot l$$
$$x \leq \frac{1}{θ} ( {\sum }_{i = 1}^{n} {x}_{i} ) \cdot u$$
where, x is the variable for optimization, i is an investment component from the n investment components in the risk parity portfolio, l is the lower limit, u is the upper limit, Σ is a covariance matrix and θ is a positive quantity that represents the proportion of the available funds to be invested in the risk parity portfolio.

22. The system of claim 21, wherein the solution corresponding to the optimal investment component weights is derived from the intermediate solution in accordance with:
$$ω = \frac{θ}{{\sum }_{i} {x}_{i}^{*}} {x}^{*}$$
where x* is the intermediate solution, θ is the proportion of the funds to be invested in the risk parity portfolio and ω is the optimal investment component weight.

23. A processor-readable non-transient medium storing instructions to:
receive a selection of investment components for inclusion in a risk parity portfolio;
obtain upper and lower limits on each investment component weight;
determine a solution corresponding to optimal investment component weights, wherein each optimal investment component weight is within the upper and lower limits, and the sum of the optimal investment component weights is equal to a specified target; and
construct the risk parity portfolio having the investment components configured in accordance with the optimal investment component weights, such that each investment component in the risk parity portfolio contributes an approximately equal amount of financial risk.

24. The medium of claim 23, further comprising instructions to:
receive the specified target, wherein the specified target represents a proportion of available funds to be invested in the risk parity portfolio.

25. The medium of claim 24, wherein the instructions to determine the solution further comprise instructions to:
constrain a convex optimization problem with the upper and lower limits on each investment component weight; and
solve the convex optimization problem to determine an intermediate solution.

26. The medium of claim 25, further comprising instructions to:
scale the intermediate solution to derive the solution corresponding to the optimal investment component weights.

27. The medium of claim 25, wherein the convex optimization problem is further constrained by requiring long only positions on the investment components.

28. The medium of claim 25, further comprising instructions to:
obtain covariance matrix of the investment components and provide the covariance matrix as an input to the convex optimization problem, wherein the convex optimization problem is of the form:
$$f ( x ) = {x}^{T} Σ x - {\sum }_{i = 1}^{n} ln {x}_{i}$$
$$x \geq \frac{1}{θ} ( {\sum }_{i = 1}^{n} {x}_{i} ) \cdot l$$
$$x \leq \frac{1}{θ} ( {\sum }_{i = 1}^{n} {x}_{i} ) \cdot u$$
where, x is the variable for optimization, i is an investment component from the n investment components in the risk parity portfolio, l is the lower limit, u is the upper limit, Σ is a covariance matrix and θ is a positive quantity that represents the proportion of the available funds to be invested in the risk parity portfolio.

29. The medium of claim 28, wherein the solution corresponding to the optimal investment component weights is derived from the intermediate solution in accordance with:
$$ω = \frac{θ}{{\sum }_{i} {x}_{i}^{*}} {x}^{*}$$
where x* is the intermediate solution, θ is the proportion of the funds to be invested in the risk parity portfolio and ω is the optimal investment component weight.
